(19) United States
(12) Patent Application Publication
(10) Pub. No.: US 2020/0213517 A1
(43) Pub. Date: Jul. 2, 2020

(54) GIMBAL CAMERA AND UNMANNED AERIAL VEHICLE HAVING THE SAME

(71) Applicant: SZ DJI TECHNOLOGY CO., LTD., Shenzhen (CN)

(72) Inventors: Chengyu YIN, Shenzhen (CN); Zihan CHEN, Shenzhen (CN)

(21) Appl. No.: 16/812,030

(22) Filed: Mar. 6, 2020

Related U.S. Application Data
(63) Continuation of application No. PCT/CN2017/101287, filed on Sep. 11, 2017.

(51) Int. Cl. H04N 5/232; H04N 5/225; B64C 39/02; B64D 47/08

(52) U.S. Cl. CPC H04N 5/23258; H04N 5/2253; H04N 5/23287; B64C 2201/127; B64D 47/08; B64C 2201/027; B64C 39/024

(57) ABSTRACT

A gimbal camera includes a camera body, a camera main control board in the camera body, and an attitude-detection circuit in the camera body and independent from the camera main control board. The attitude-detection circuit is electrically connected to the camera main control board. The attitude-detection circuit includes an inertial measurement unit on one side of the attitude-detection circuit away from the camera main control board.

### CROSS-REFERENCE TO RELATED APPLICATION

This application is a continuation of International Application No. PCT/CN2017/101287, filed on Sep. 11, 2017, the entire content of which is incorporated herein by reference.

### TECHNICAL FIELD

The present disclosure relates to the field of photographing devices and, more particularly, to a gimbal camera and an unmanned aerial vehicle (UAV) having the same.

### BACKGROUND

With development of photographing technologies, users often have increasing requirements for images captured by cameras. Accuracy of camera position can affect accuracy of captured images. For achieving stabilization of the camera, the camera may be fixed on a gimbal, and the stabilization of the camera may be achieved by using motors of the gimbal to compensate shaking of the gimbal in real-time.

### SUMMARY

In accordance with the disclosure, there is provided a gimbal camera. The gimbal camera includes a camera body, a camera main control board in the camera body, and an attitude-detection circuit in the camera body and independent from the camera main control board. The attitude-detection circuit is electrically connected to the camera main control board. The attitude-detection circuit includes an inertial measurement unit on one side of the attitude-detection circuit away from the camera main control board.

Also in accordance with the disclosure, there is provided an unmanned aerial vehicle including a fuselage and a gimbal camera mounted on the fuselage. The gimbal camera includes a camera body, a camera main control board in the camera body, and an attitude-detection circuit in the camera body and independent from the camera main control board. The attitude-detection circuit is electrically connected to the camera main control board, and the attitude-detection circuit includes an inertial measurement unit on one side of the attitude-detection circuit away from the camera main control board.

### BRIEF DESCRIPTION OF THE DRAWINGS

In order to explain the technical solutions of the present disclosure, the accompanying drawings used in the descriptions of embodiments are briefly introduced below. The accompanying drawings in the following descriptions are merely part of the embodiments of the present disclosure. Other drawings conceived by those having ordinary skills in the art on the basis of the described drawings without inventive efforts should fall within the scope of the present disclosure.

FIG. 1 illustrates a cross-sectional view of a gimbal camera according to various embodiments of the present disclosure;

FIG. 2 illustrates a schematic structural diagram of a part of a gimbal camera according to various embodiments of the present disclosure;

FIG. 3 illustrates a schematic structural diagram of a part of a gimbal camera in another direction according to various embodiments of the present disclosure;

FIG. 4 illustrates a schematic structural diagram of a part of a gimbal camera in another direction according to various embodiments of the present disclosure; and

FIG. 5 illustrates a perspective view of an unmanned aerial vehicle according to various embodiments of the present disclosure.

Reference numerals used in the drawings include: 100: fuselage; 200: gimbal camera; 1: camera body; 2: camera main control board; 3: attitude-detection circuit; 31: inertial measurement unit; 32: heating element; 33: first connection end; 34: second connection end; 4: connector; 5: support member; and 6: gimbal.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

Exemplary embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

A gimbal camera 200 consistent with the present disclosure and an unmanned aerial vehicle (UAV) having the gimbal camera 200 are described in detail below with reference to accompanying drawings. The embodiments and the features of the embodiments may be combined under conditions that there are no conflicts.

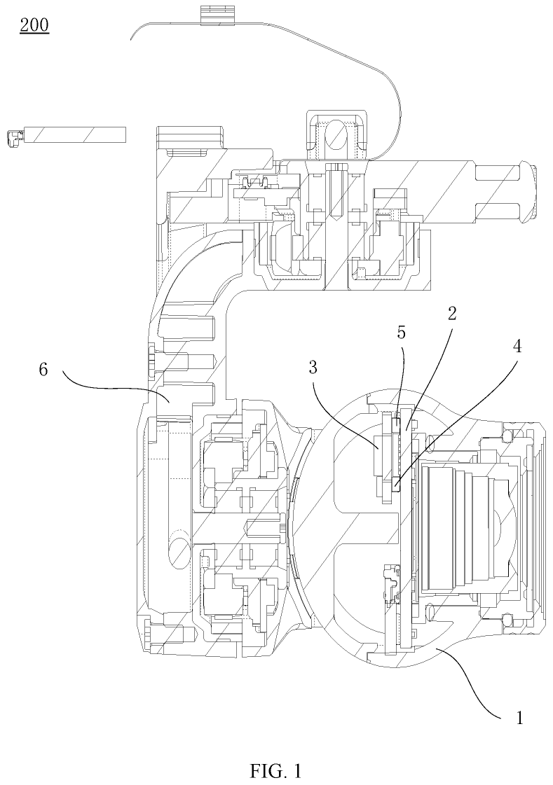

Referring to FIG. 1, in some embodiments, a gimbal camera 200 is provided. The gimbal camera 200 may include a camera body 1, a camera main control board (CMCB) 2, and an attitude-detection circuit 3. The CMCB 2 and the attitude-detection circuit 3 are arranged in the camera body 1. The attitude-detection circuit 3 is independent of the CMCB 2 and is electrically connected to the CMCB 2. In some embodiments, the attitude-detection circuit 3 may transmit camera-attitude data detected by the attitude-detection circuit 3 to the CMCB 2, and the CMCB 2 may further process the camera-attitude data and compensate in real-time the shaking of the gimbal, so as to achieve stabilization of the camera. In some other embodiments, the gimbal camera 200 may be mounted on a UAV, and the attitude-detection circuit 3 may transmit the detected camera-attitude data to a flight controller of the UAV. Further, the flight controller may process the camera-attitude data and compensate the shaking of the gimbal in real-time, so as to achieve the stabilization of the camera. The attitude-detection circuit 3 may be electrically connected to the flight controller directly, or may be electrically connected to the flight controller by adapting via the CMCB 2.

The attitude-detection circuit 3 may include an inertial measurement unit (IMU) 31 and the camera attitude may be detected by the inertial measurement unit 31. The inertial measurement unit 31 may be arranged on one side of the attitude-detection circuit 3 away from the CMCB 2. That is, the inertial measurement unit 31 may be arranged on one side of the attitude-detection circuit 3, and the side is away from the CMCB 2.

In current technologies, an attitude-detection circuit and a CMCB often share a same circuit board for miniaturization design of a gimbal camera. An inertial measurement unit requires high accuracy and, thus, is easily affected by factors such as temperature, stress, etc., resulting in inaccuracy in detected data and affecting stability enhancement by a gimbal. To prevent the inertial measurement unit from being affected by temperature, stress, etc., an isolation region is often be arranged around the inertial measurement unit. The isolation region excessively occupies the area of the circuit board, resulting in a low utilization rate of the circuit board, and further, the isolation region results in difficulties in wiring in the circuit board, against requirements for miniaturization design of the gimbal camera.

According to the present disclosure, by configuring an independent attitude-detection circuit 3 and arranging the inertial measurement unit 31 on the side of the attitude-detection circuit 3 that is away from the CMCB 2, the inertial measurement unit 31 may be as far away from the CMCB 2 as possible, and thus components on the CMCB 2, such as sensors, may be prevented from interfering with the inertial measurement unit 31, including influences of stress and temperature. Accordingly, stress isolation and thermal isolation of the inertial measurement unit 31 can be achieved, and measurement accuracy of the inertial measurement unit 31 can be improved. The attitude-detection circuit 3 may be configured separately and, thus, after the inertial measurement unit 31 is damaged, the attitude-detection circuit 3 can be directly replaced without the need to replace the CMCB 2, so as to reduce cost, and satisfy the requirements for miniaturization design of the CMCB 2.

With reference to FIGS. 1, 2, and 4, the gimbal camera 200 may further include a connector 4, and the attitude-detection circuit 3 may be electrically connected to the CMCB 2 through the connector 4. The connector 4 may be arranged between the CMCB 2 and the attitude-detection circuit 3. By using the connector 4 to support the attitude-detection circuit 3, the attitude-detection circuit 3 may be prevented from directly pressing on the CMCB 2 and thus from damaging components on the CMCB 2.

The connector 4 may be, for example, a board-to-board connector, a flexible printed circuit (FPC), or other suitable type of connector. A type of the connector 4 may be chosen according to actual needs, and is not limited in the present disclosure.

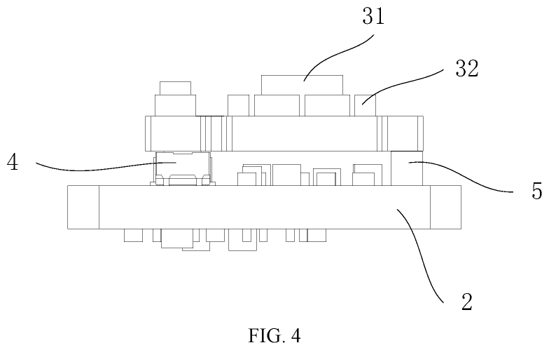

Referring to FIG. 4, the CMCB 2 and the attitude-detection circuit 3 are arranged in parallel to each other at a preset distance, so as to further prevent the CMCB 2 from interfering with the inertial measurement unit 31. Further, the preset distance may be determined according to a maximum height of components (not labeled in FIG. 4) on one side of the CMCB 2 near the attitude-detection circuit 3. That is, the preset distance may be determined according to a maximum height of components on one side of the CMCB 2, where the side is a side near the attitude-detection circuit 3. For example, in some embodiments, the preset distance may be the maximum height of the components on one side of the CMCB 2 near the attitude-detection circuit 3, satisfying requirements for miniaturization design of the device. In some other embodiments, the preset distance may be greater than a maximum height of components on one side of the CMCB 2 near the attitude-detection circuit 3.

The fixing manner of the attitude-detection circuit 3 can be configured according to actual needs. For example, in some embodiments, the attitude-detection circuit 3 may be fixed on the CMCB 2. In some embodiments, the gimbal camera 200 may further include a support member 5. One end of the support member 5 may be connected to the CMCB 2, and another end of the support member 5 may be connected to the attitude-detection circuit 3, such that the attitude-detection circuit 3 may be fixed stably to the CMCB 2. Accordingly, inaccurate detection of the camera attitude caused by shaking of the attitude-detection circuit 3 may be prevented. Further, the support member 5 and the connector 4 may be configured to be opposite to each other. The attitude-detection circuit 3 may include a first connection end 33 and a second connection end 34, and the first connection end 33 may be fixedly and electrically connected to the CMCB 2 via the connector 4, and the second connection end 34 may be fixedly connected to the CMCB 2 via the support member 5. The first connection end 33 and the second connection end 34 of the attitude-detection circuit 3 may be fixed to the CMCB 2 by using the connector 4 and the support member 5, respectively, and accordingly, connection stability between the attitude-detection circuit 3 and the CMCB 2 can be improved, and inaccurate detection of the camera attitude caused by shaking of the attitude-detection circuit 3 may be prevented.

In some embodiments, the attitude-detection circuit 3 may be fixed on the camera body 1 to prevent the attitude-detection circuit 3 from shaking. In some embodiments, the attitude-detection circuit 3 may be directly fixed on an inner wall of the camera body 1, e.g., an inner side-wall of the camera body 1, by means of snap-in, plug-in, or the like, or may be fixed in the camera body 1 by using an adapter.

Further, an adhesive layer (not shown in FIG. 4) may be provided between the CMCB 2 and the attitude-detection circuit 3, such that the attitude-detection circuit 3 is more stably connected to the CMCB 2. Accordingly, the attitude-detection circuit 3 may be prevented from shaking. A material of the adhesive layer may be, for example, glue, resin, or other suitable adhesive material.

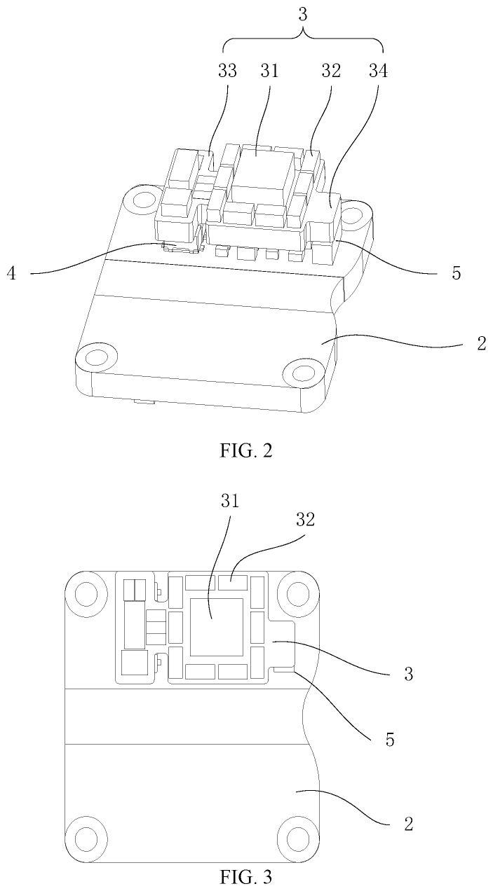

With reference to FIGS. 2 to 4, the attitude-detection circuit 3 may further include a heating element 32. Further, the heating element 32 may be arranged on one side of the attitude-detection circuit 3 away from the CMCB 2 and may be arranged near the inertial measurement unit 31. The heating element 32 may transmits heat from a heat source to surrounding air flow, so as to keep the inertial measurement unit 31 at a constant-temperature state and reduce influences of temperature changes on the inertial measurement unit 31. It should be understood that, the heating element 32 may be arranged to be close to the inertial measurement unit 31, but the heating element 32 may not directly contact the inertial measurement unit 31. In fact, certain distance may exist between the heating element 32 and the inertial measurement unit 31, so as to prevent direct contact between the heating element 32 and the inertial measurement unit 31 and thus prevent direct heat transfer to the inertial measurement unit 31. Accordingly, damage of the inertial measurement unit 31 caused by accumulated excessive heat may be prevented.

The number of the heating elements 32 can be chosen according to the size of the inertial measurement unit 31. In some embodiments, there may be a plurality of heating elements 32, i.e., at least two heating elements 32. The plurality of the heating elements 32 may surround the inertial measurement unit 31, so as to keep the air flow around the inertial measurement unit 31 at a constant temperature, and further keep the inertial measurement unit 31 in a constant-temperature state.

Further, a plurality of heating elements 32 can be evenly distributed around the inertial measurement unit 31, and can evenly heat around the inertial measurement unit 31, so as to ensure temperature uniformity of the air flow around the inertial measurement unit 31. Accordingly, the inertial measurement unit 31 may be kept at a constant-temperature state.

Further, the type of the heating element 32 may also be chosen according to actual needs. For example, the heating element 32 may be chosen as a heating resistor or other suitable heating source.

It should be understood that in addition to the inertial measurement unit 31 and the heating element 32, the attitude-detection circuit 3 may further include other components.

In some embodiments, the inertial measurement unit 31 may be hung in the camera body 1, so as to more accurately detect the camera attitude.

Further, the fixing manner of the CMCB 2 can be configured according to actual needs. In some embodiments, the CMCB 2 may be directly fixed on an inner wall of the camera body 1, e.g., an inner side wall of the camera body 1. For example, the CMCB 2 may be fixed on the inner wall of the camera body 1 by means of snap-in, plug-in, or the like. In some other embodiments, the CMCB 2 may be fixed in the camera body 1 by adapting using an adapter.

Referring to FIG. 1, the gimbal camera 200 further includes a gimbal 6 for mounting the camera body 1, so as to achieve stabilization of the camera via the gimbal 6. The gimbal 6 may be, for example, a two-axis gimbal, a three-axis gimbal, etc. The gimbal 6 may include motors for corresponding axes that drive the camera body 1 to rotate, which may include a pitch axis, a roll axis, and/or a yaw axis. In some embodiments, the inertial measurement unit 31 may transmit detected attitude data of the camera to the CMCB 2 or a flight controller of the UAV configured to carry the gimbal camera 200. Further, the CMCB 2 or the flight controller may generate control instructions and send the control instructions to the motors of the corresponding axes according to the attitude data of the camera, so as to compensate shaking of the gimbal 6 in real-time and achieve stabilization of the camera.

In some embodiments, a plurality of function circuits may be integrated in the CMCB 2, so as to save available space in the camera body 1 and provide possibilities for miniaturization of the gimbal camera 200. For example, the function circuits may be configured to at least control operations of the camera and/or the gimbal 6, e.g., control camera to capture image and focus, control rotations of a gimbal motor, etc. As another example, the function circuit may be configured to at least collect data information. The data information may at least include one or more types of information among image data information captured by the camera; motor parameters of the gimbal, e.g., a rotation angle of a motor for each axis; and camera parameter information, e.g., shutter control parameters, aperture parameters, exposure parameters, exposure modes, white balance parameters, etc. The data information may further include other data information relevant to the camera and/or the gimbal 6. The function circuit may further include other functions for controlling operations of the gimbal 6 and/or the camera. By integrating functions required for the operations of the gimbal 6 and/or the camera to the CMCB 2, the structure may be more compact, so as to effectively reduce a volume of the gimbal camera 200. Accordingly, the gimbal camera 200 can be further miniaturized.

In some embodiments, the gimbal camera 200 may be mounted on any suitable device that can move, such as a UAV. Further descriptions are made by taking the gimbal camera 200 mounted on a UAV as an example.

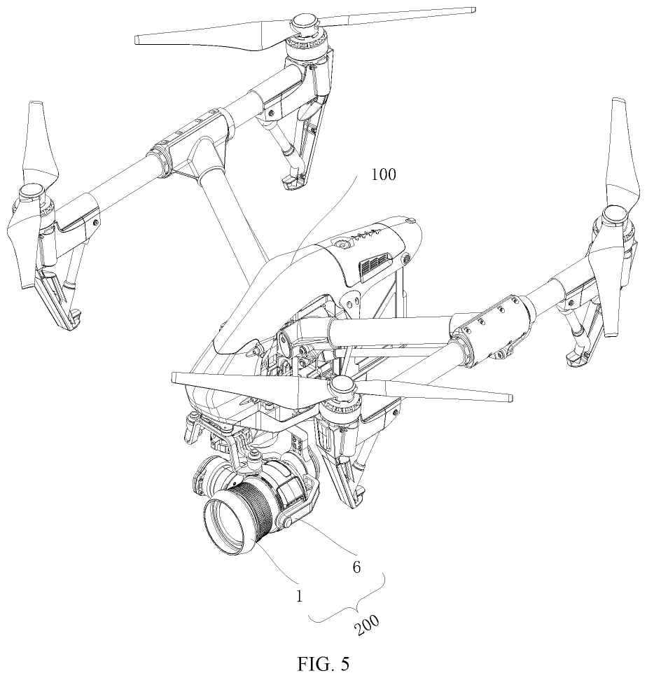

Referring to FIG. 5, the present disclosure further provides a UAV. The UAV may include a fuselage 100 and a gimbal camera 200 consistent with any one of the embodiments of the present disclosure, including the above-described embodiments. The gimbal camera 200 is mounted on the fuselage 100.

The UAV may be, for example, a rotary-wing UAV, a non-rotary-wing UAV, etc.

It should be understood that relational terms such as “first,” “second,” and the like are merely intended to distinguish between similar objects or similar operations but do not necessarily require or indicate an actual relationship or order between the similar objects or similar operations. The terms “include,” “contain,” and/or any other similar expressions are intended to cover non-exclusive inclusion, such that a process, method, article, or device that includes a series of elements includes not only those elements that are explicitly listed, but also other elements not explicitly listed and/or elements that are inherent to such a process, method, article, or device. Without further restrictions, defining an element by the expression “including an element” or any other similar expressions may not exclude the existence of other identical elements in the process, method, article, or device that includes the element.

Those of ordinary skill in the art will appreciate that the exemplary elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of exemplary systems, devices, and units may be omitted and references can be made to the descriptions of the exemplary methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A gimbal camera comprising:
a camera body;
a camera main control board in the camera body; and
an attitude-detection circuit in the camera body and independent from the camera main control board, wherein:
the attitude-detection circuit is electrically connected to the camera main control board, and
the attitude-detection circuit includes an inertial measurement unit on one side of the attitude-detection circuit away from the camera main control board.

2. The gimbal camera according to claim 1, wherein:
the camera main control board and the attitude-detection circuit are disposed in parallel to each other at a preset distance.

3. The gimbal camera according to claim 1, wherein:
the attitude-detection circuit further includes a heating element, and
the heating element is on the one side of the attitude-detection circuit away from the camera main control board and is close to the inertial measurement unit.

4. The gimbal camera according to claim 3, wherein:
the attitude-detection circuit includes a plurality of heating elements, and
the plurality of heating elements surround the inertial measurement unit.

5. The gimbal camera according to claim 3, wherein:
the heating element is a heating resistor.

6. The gimbal camera according to claim 1, further comprising:
a connector between the camera main control board and the attitude-detection circuit, wherein the attitude-detection circuit is electrically connected to the camera main control board via the connector.

7. The gimbal camera according to claim 6, wherein:
the connector is a board-to-board connector or a flexible circuit.

8. The gimbal camera according to claim 6, further comprising:
a support member having one end connected to the camera main control board and another end connected to the attitude-detection circuit.

9. The gimbal camera according to claim 8, wherein:
the support member and the connector are opposite to each other, and
the attitude-detection circuit includes:
a first connection end fixedly and electrically connected to the camera main control board via the connector, and
a second connection end fixedly connected to the camera main control board via the support member.

10. The gimbal camera according to claim 6, wherein:
the attitude-detection circuit is fixed on the camera body.

11. The gimbal camera according to claim 1, wherein:
an adhesive layer is provided between the camera main control board and the attitude-detection circuit.

12. The gimbal camera according to claim 1, wherein:
a plurality of function circuits are integrated in the camera main control board, and
the plurality of function circuits are configured to perform at least one of:
controlling operations of at least one of camera or gimbal, or
collecting data information.

13. The gimbal camera according to claim 12, wherein:
the data information at least includes one or more types of information among image data information captured by the camera, motor parameters of the gimbal, and camera parameter information.

14. An unmanned aerial vehicle comprising:
a fuselage, and
a gimbal camera mounted on the fuselage and including:
a camera body,
a camera main control board in the camera body, and
an attitude-detection circuit in the camera body and independent from the camera main control board, wherein:
the attitude-detection circuit is electrically connected to the camera main control board, and
the attitude-detection circuit includes an inertial measurement unit on one side of the attitude-detection circuit away from the camera main control board.

15. The unmanned aerial vehicle according to claim 14, wherein:
the camera main control board and the attitude-detection circuit are disposed in parallel to each other at a preset distance.

16. The unmanned aerial vehicle according to claim 14, wherein:
the attitude-detection circuit further includes a heating element, and
the heating element is on the one side of the attitude-detection circuit away from the camera main control board and is close to the inertial measurement unit.

17. The unmanned aerial vehicle according to claim 16, wherein:
the attitude-detection circuit includes a plurality of heating elements, and
the plurality of heating elements surround the inertial measurement unit.

18. The unmanned aerial vehicle according to claim 16, wherein:
the heating element is a heating resistor.

19. The unmanned aerial vehicle according to claim 14, further comprising:
a connector between the camera main control board and the attitude-detection circuit, wherein the attitude-detection circuit is electrically connected to the camera main control board via the connector.

20. The unmanned aerial vehicle according to claim 19, wherein:
the connector is a board-to-board connector or a flexible circuit.
